(19) United States
(12) Patent Application Publication
(10) Pub. No.: US 2015/0000224 A1
(43) Pub. Date: Jan. 1, 2015

(54) MODULAR WALL STUD BRACE

(71) Applicant: INT'L SHEAR LOCK SYSTEMS INC., Kelowna (CA)

(72) Inventors: Abtar Shar Sidhu, Kelowna (CA); Anthony Theodorus Groenesteyn, West Kelowna (CA)

(21) Appl. No.: 14/370,676

(22) PCT Filed: Jun. 8, 2012
(86) PCT No.: PCT/CA2012/050389

§ 371 Date: Jul. 3, 2014

Related U.S. Application Data
(60) Provisional application No. 61/583,607, filed on Jan. 6, 2012.

(51) Int. Cl. E04C 5/16; F16B 9/00

(52) U.S. Cl. CPC E04C 5/162; F16B 9/00
USPC 52/698

(57) ABSTRACT

An apparatus for reinforcing a plurality of adjacent parallel spaced apart wooden structural members to each other. Each of the structural members extends between first and second ends and has first and second edges. The apparatus comprises a ridged member extending between first and second ends and having a length sufficient to extend between two adjacent structural members. The apparatus further comprises a socket at each of the first and second ends of the rigid member. Each socket has a central axis therethrough and is formed of a base panel and first and second side panels. The socket is adapted to engage with a socket of an adjacent rigid member so as to interlink successive rigid members across a plurality of structural members.

### BACKGROUND OF THE INVENTION

1. Field of Invention

The present invention relates to structural reinforcement in general and in particular to reinforcing adjacent wall studs to each other.

2. Description of Related Art

In the field of construction, it is often desirable to make a structure as strong as possible. The strength of a building is desirable for the purposes of load bearing ability as well as resistance to outside loads such as earthquakes, wind and other environmental loading.

Building construction typically includes a plurality of elongate members connected each other to form walls, ceilings, floor and the like. In the case of walls, such elongate wall members are often referred to as studs while in ceilings and roofs, they may be referred to as joist.

One difficulty that exists is the tendency of relatively long structural members to lose strength and rigidity as their length increases. This is particularly a difficulty for relatively long slender members such as wall studs and the like. Such wall studs may commonly be subject to buckling failure. Another difficulty that exists with wall studs is that walls formed by conventional wall studs is that such construction techniques may be less resistant to shear loads than they are to compressive loads. Under such loads, wall studs may be prone to rotate about their end connections to the top and bottom plate. The resulting deflection of the entire load above such a wall may contribute to an entire building failing or collapsing.

### SUMMARY OF THE INVENTION

According to a first embodiment of the present invention there is disclosed an apparatus for reinforcing a plurality of adjacent parallel spaced apart wooden structural members to each other. Each of the structural members extends between first and second ends and has first and second edges. The apparatus comprises a ridged member extending between first and second ends and having a length sufficient to extend between two adjacent structural members. The apparatus further comprises a socket at each of the first and second ends of the rigid member. Each socket has a central axis therethrough and is formed of a base panel and first and second side panels. The socket is adapted to engage with a socket of an adjacent rigid member so as to interlink successive rigid members across a plurality of structural members.

The base panel of each socket may be abuttable at against a corresponding base panel wherein the first and second side panels are engagable with corresponding first and second side panels of the adjacent socket. The side panels of the socket may overlap the side panels of the adjacent socket when the socket is engaged therewith.

The base panel may extend between first and second edges wherein one of the first or second edges abuts against a corresponding first or second edge of the adjacent socket. The one of the first or second edge may be angularly oriented relative to the central axis.

The first and second panels may include fastener bores therethrough adapted to align with corresponding bores in the first and second panels of the adjacent socket. The central axes of the first and second sockets may be substantially parallel to each other.

The rigid member may extend diagonally between the first and second sockets, such that the rigid member is angularly oriented relative to the central axis of the first and second socket. The first and second side panels may be co-formed with the base panel. The base panel may be co-formed with the rigid member. The apparatus may be formed of a material selected from the group consisting of metal, plastic, wood and composite materials.

The first and second side panels may include end tabs connectable to adjacent end tabs of an corresponding socket of an adjacent rigid member.

According to a further embodiment of the present invention there is disclosed a kit for reinforcing a plurality of adjacent parallel spaced apart wooden structural members to each other. Each of the structural members extends between first and second ends and has first and second edges. The kit comprises a plurality of apparatuses each comprising a ridged member extending between first and second ends and having a length sufficient to extend between two adjacent structural members. Each apparatus further comprises a socket at each of the first and second ends of the rigid member. Each socket has a central axis therethrough and is formed of a base panel and first and second side panels. The socket is adapted to engage with a socket of an adjacent rigid member so as to interlink successive rigid members across a plurality of structural members.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a perspective view of a plurality of apparatuses according to a first embodiment of the present invention for reinforcing structural members located across wall studs.

FIG. 2 is a front perspective view of one of the apparatuses of FIG. 1.

FIG. 3 is a rear perspective view of one of the apparatuses of FIG. 1.

FIG. 4 is a front profile view of two of the apparatuses of FIG. 2 applied to a wall stud.

FIG. 5 is a cross-sectional view of the two apparatus of FIG. 4 as taken along the line 5-5.

FIG. 6 is a plan view of a cut sheet for forming the apparatus of FIG. 2.

FIG. 7 is a plan view of a cut sheet for forming an apparatus for reinforcing structural members located across wall studs according to a further embodiment of the present invention.

FIG. 8 is a front profile view of an apparatus for reinforcing structural members according to a further embodiment of the present invention.

FIG. 9 is a detailed perspective view of one of the sockets of the apparatus of FIG. 8.

### DETAILED DESCRIPTION

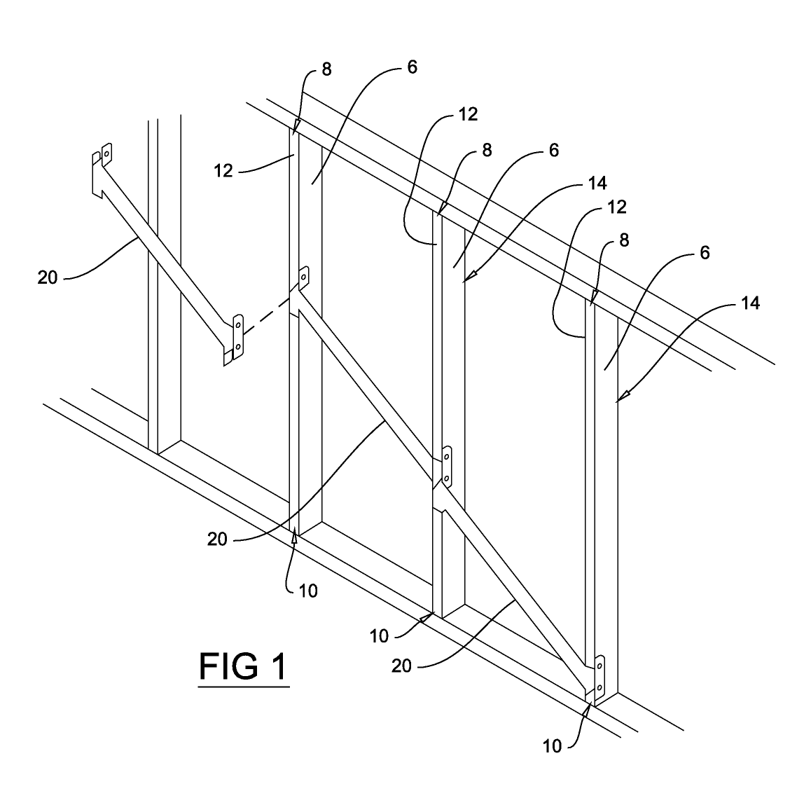

Referring to FIG. 1, an apparatus for stabilizing adjacent wall studs 6 according to a first embodiment of the invention is shown generally at 20. The wall studs 6 may be of any conventional type, such as by way of non-limiting example dimensioned lumber, engineered studs, composite material studs or metal studs and extend between top and bottom ends, 8 and 10, respectively. It will also be appreciated that the present apparatus may be useful for stabilizing any other type of wall structural member, such as, by way of non-limiting example, floor joists roof trusses or the like. The wall studs 6 as illustrated have front and rear surfaces, 12 and 14, respectively, as are conventionally known.

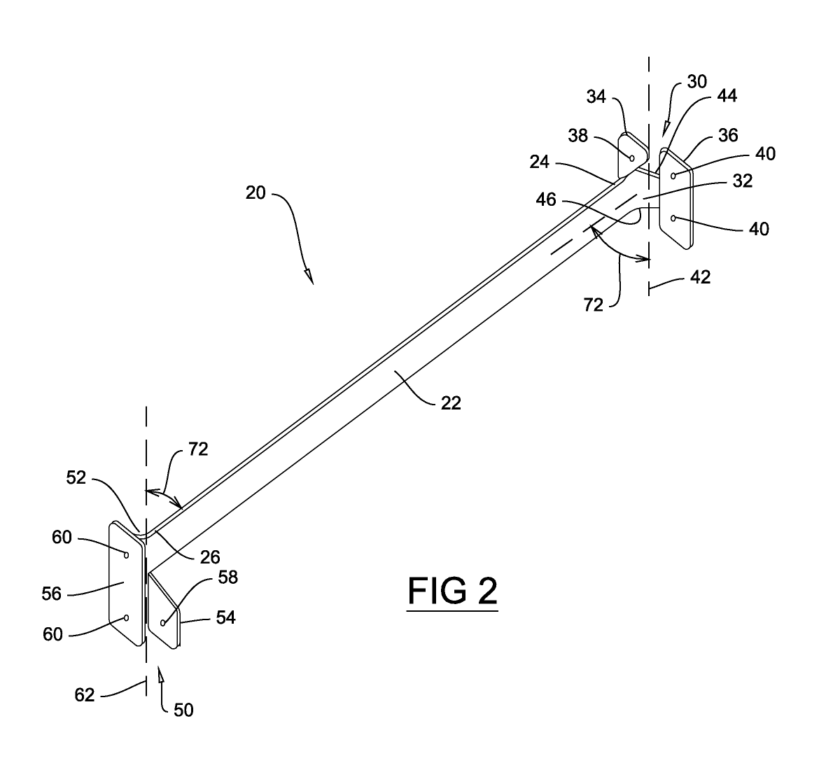

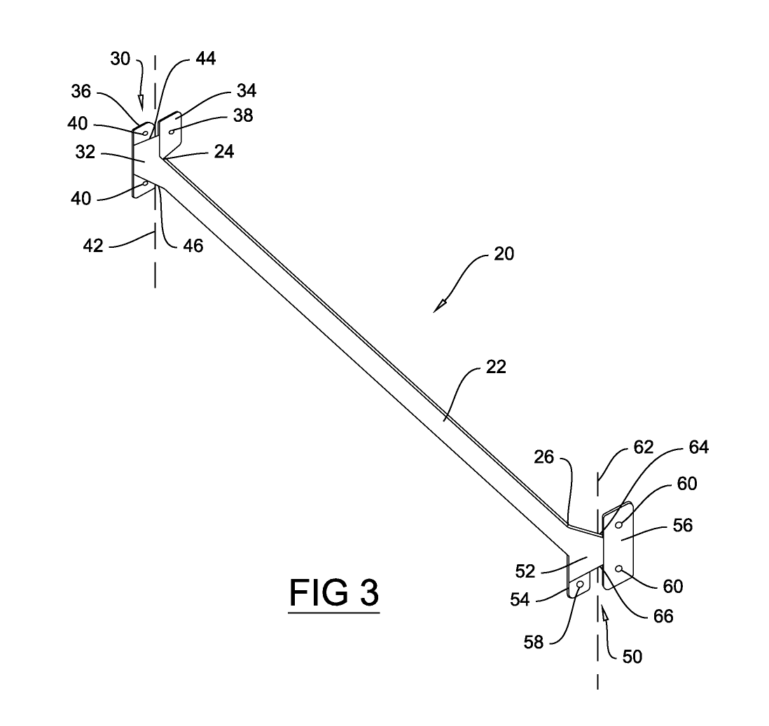

With reference to FIGS. 2 and 3, the apparatus 20 comprises a rigid member 22 extending between first and second ends, 24 and 26, respectively. The first and second ends have first and second sockets 30 and 50, respectively extending therefrom. As illustrated in FIG. 1, the first and second sockets are adapted to receive one of the front or rear surfaces 12 or 14 of the wall studs 6 therein. As further illustrated in FIG. 1, the first socket 30 of one apparatus is engagable with a second socket 50 of an adjacent apparatus so as to be interlocked therewith as will be more fully described below.

The rigid member 22 may be formed of any known shape. As illustrated, the rigid member 22 may be formed of a substantially planar member, although it will be appreciated that other shapes may be useful as well, such as, by way of non-limiting example, a tube, a bar, a box section, an I-beam, a c-shaped channel, an L-shaped channel or a triangular cross section beam. It will also be appreciated that the rigid member 22 may also include strengthening flanges or ribs extending therefrom as are commonly known. The rigid member 22 may be formed of any suitable material, such as, by way of non-limiting example, metal, plastic, ceramics or the like. It will also be appreciated that although the apparatus 20 may be formed of bent sheet metal, it may also be formed by other means such as an extruded, cast or welded structure.

The first socket 30 is formed of a base panel 32 having first and second side panels, 34 and 36, respectively extending therefrom. The first and second side panels 34 and 36 extend substantially perpendicularly from the base panel 32 so as to form a u-shaped socket along a central axis 42 for receiving the wall stud 6 therein. It will be appreciated that the width of the base panel may be selected to space the first and second side panels apart by a distance corresponding to the width of the wall stud such as approximately 1.5 inches (38 mm) for use with a conventional 2×4 dimension lumber wall stud, by way of non-limiting example. Each of the first and second side panels includes fastener bores 38 and 40, respectively, therethrough sized to receive fasteners, such as, by way of non-limiting example, screws or nails therethrough as will be more fully described below.

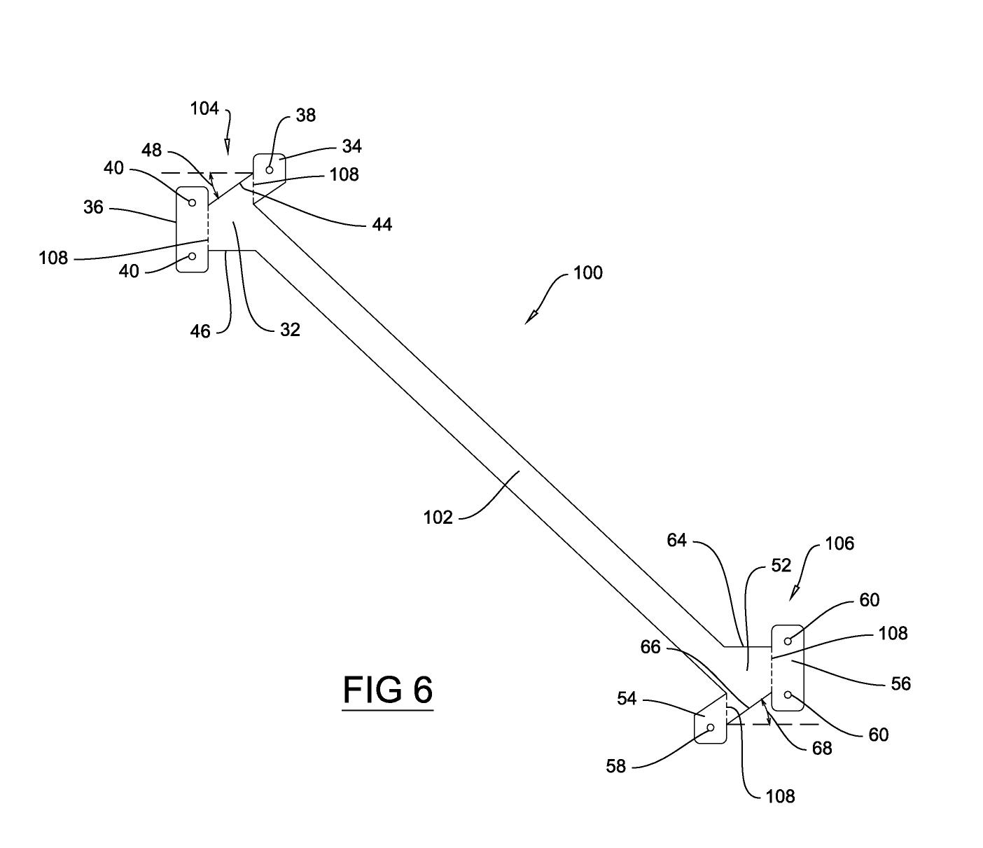

The base plate comprises a substantially planar member extending between top and bottom edges, 44 and 46, respectively. As illustrated, the bottom edge 46 may be substantially perpendicular to the central axis 42 of the socket while the top edge 44 is angularly oriented relative to the central axis 42. As illustrated in FIG. 6, the top edge may have a top incline angle, generally indicated at 48 of between 0 and 60 degrees relative to a plane perpendicular to the central axis. As illustrated, the first side panel 34 may have a length selected to extend above and below the top and bottom edges 44 and 46 of the base panel 32 while the second side has a length selected to extend above the top edge 44 of the base panel 32.

The second socket 50 is formed of a base panel 52 having first and second side panels, 54 and 56, respectively extending therefrom. The first and second side panels 54 and 56 extend substantially perpendicularly from the base panel 52 so as to form a u-shaped socket along a central axis 62 for receiving the wall stud 6 therein. It will be appreciated that the width of the base panel may be selected to space the first and second side panels apart by a distance corresponding to the width of the wall stud such as approximately 1.5 inches (38 mm) for use with a conventional 2×4 dimension lumber wall stud, by way of non-limiting example. Each of the first and second side panels includes fastener bores 58 and 60, respectively, therethrough sized to receive fasteners, such as, by way of non-limiting example, screws or nails therethrough. As will be more fully described below the fastener bores 38, 40, 58 and 60 may be located such that a common fasteners may be passed through a pair of corresponding bores when adjacent apparatuses are secured together.

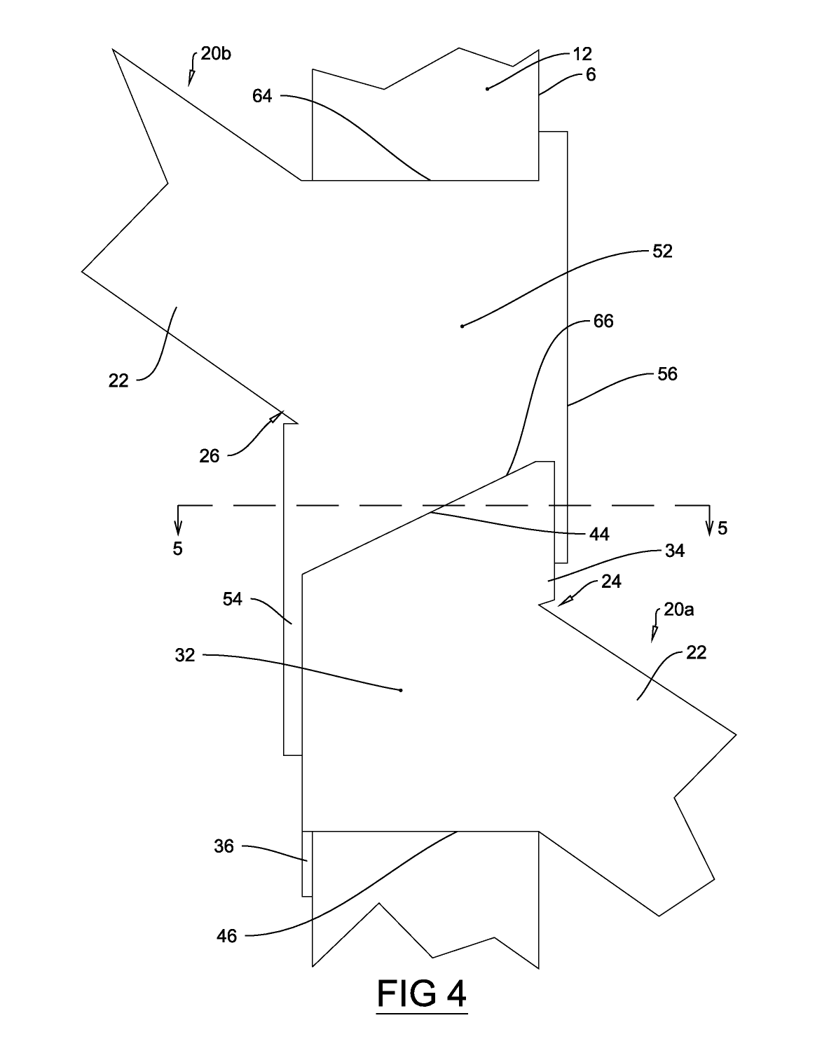

The base panel 52 comprises a substantially planar member extending between top and bottom edges, 64 and 66, respectively. As illustrated, the top edge 64 may be substantially perpendicular to the central axis 42 of the socket while the bottom edge 66 is angularly oriented relative to the central axis 42. As illustrated in FIG. 6, the bottom edge may have a bottom incline angle, generally indicated at 68 of between 0 and 60 degrees relative to a plane perpendicular to the central axis. The top and bottom incline angles 48 and 68 will be selected to correspond to each other such that when sockets of adjacent apparatuses 20 are located adjacent to each other, they may be abutted against each other as illustrated in FIGS. 1 and 4. As illustrated, the first side panel 34 may have a length selected to extend above and below the top and bottom edges 44 and 46 of the base panel 32 while the second side has a length selected to extend above the top edge 44 of the base panel 32. In such a manner, the first and second side plates of such abutted sockets may be overlapped with each other as will be more fully described below.

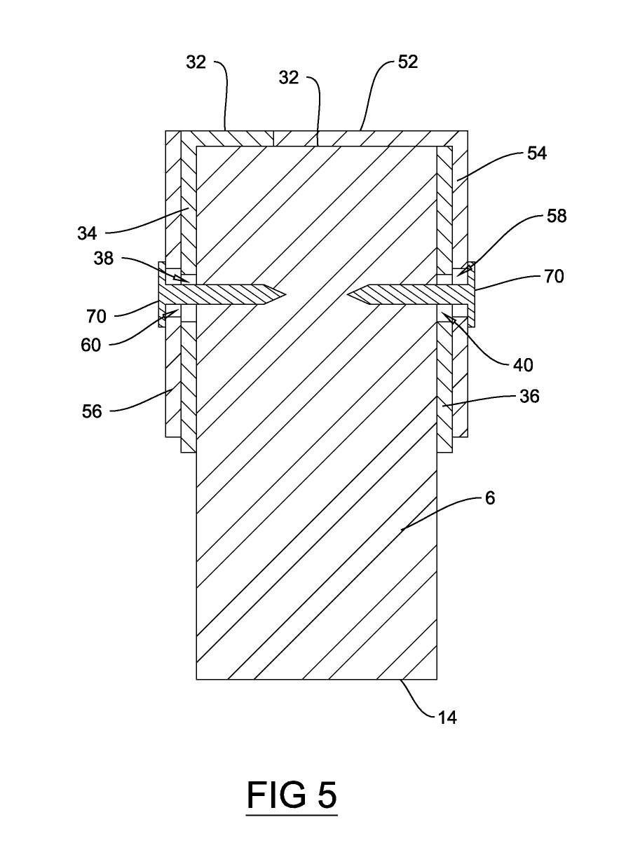

With reference to FIG. 4, in operation, a first apparatus 20a may be located on a wall stud 6 with the front edge 12 of the wall stud received within a first socket 30. Thereafter, a second apparatus 20b, may be located on the same wall stud 6 with front edge 12 of the wall socket being received within the second socket 50 at a position above the first socket 30 of the first apparatus 20a. Thereafter, the second apparatus 20b may be moved in a downward direction so as to engage the bottom edge 66 of the second socket 50 of the second apparatus 20b against the top edge 44 of the first socket 30 of the first apparatus 20a. In such a position, the first and second side panels 54 and 56 of the second socket on the second apparatus will overlap the first and second side panels 34 and 36 of the first socket of the first apparatus. Thereafter, fasteners 70 may be passed through corresponding sets of bores 38 and 60 and 58 and 40 as illustrated in FIG. 5. Optionally, the sockets 30 and 50 may include barbs, spikes or other suitable projections from an interior surface thereof so as to engage the wall stud when the apparatus 20 is secured thereto.

The rigid member 22 has a length selected to extend between adjacent wall studs 6. By way of non-limiting example, the rigid member has a length sufficient to space the central axes 42 and 62 of the first and sockets apart by a distance corresponding to the distance between the wall studs. Such spacing will be dictated by the wall construction type and may therefore be of any suitable range, such as by way of non-limiting example, 16 inches (406 mm) for 16 inch on center construction walls. It will be appreciated that other distances may be suitable as well. As illustrated, the rigid member extends away from each socket so as to form an incline angle, generally indicated at 72 between the rigid member 22 and the central axes 42 and 62 of the first and second sockets. The incline angle 72 is selected to permit the apparatus to extend diagonally between adjacent wall studs and may have an angle of between 30 and 60 degrees with an angle of 45 degrees having been found to be particularly useful.

As illustrated, the base panels 32 and 52 may be formed of a continuation of the rigid member 22 or may be a separate member secured thereto by fasteners, adhesives or the like. It will be appreciated that in embodiments where the base panels are co-formed with the rigid member, that the rigid member and base panels 32 and 52 will be co-planar with the rigid member 22.

With reference to FIG. 6, the apparatus 20 may be cut from a single sheet of metal, such as, by way of non-limiting example, steel, stainless steel, aluminium or galvanized steel. The sheet metal may be cut into a blank according to known methods and thereafter bend into the desired shape as illustrated and described above. Any thickness of metal as required to provide the necessary strength may be utilized such as between 12 and 22 gauge. In particular, it has been found that sheet metal of between 16 and 20 gauge has been useful. It will also be appreciated that the apparatus 20—may also be formed of non-metal materials, such as, by way of non-limiting example, carbon fibre, fibreglass, plastics, ceramics and composite materials. It will also be appreciated that although elongate, substantially straight members are shown, non-straight members may also be utilized, such as, by way of non-limiting example, arcuate, space frame, plates or any other shape as long as the sockets 24 and 26 are rigidly translationally fixed relative to each other so as to securely locate the adjacent structural member relative to each other.

The sheet metal may be cut into a blank according to known methods and thereafter bend into the desired shape as illustrated and described above. In particular, the blank may include a central portion 102 which forms the rigid member 22, top and bottom portions, 102 and 104, respectively having an outline sufficient to be bent along bend lines 108 to form the top and bottom sockets 30 and 50 as described above. Thereafter, the blank 100 may be folded along the fold lines 108 to form the desired final apparatus.

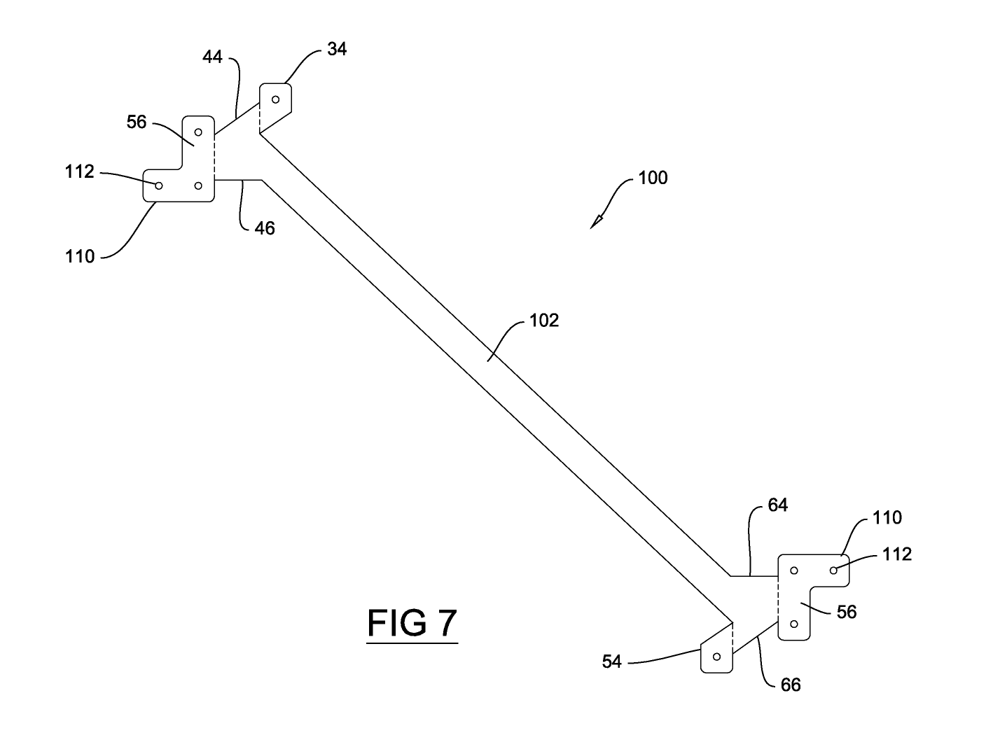

With reference to FIG. 7, a blank for forming an optional embodiment of the present invention is illustrated having extension tabs 110 extending from the second side panels 36 and 56 of the first and second sockets. The extension tabs 110 may include additional bores 112 therethrough sized to pass fasteners therethrough as described above. The extension tabs 110 may have a length sufficient to extend to and engage with a socket applied to a rear edge 14 of the wall stud when the socket is applied to a front surface of the wall stud wherein a single fastener may be passed through both bores 112. Optionally, the extension tab 110 may have a length sufficient to pass around the rear edge 114 of the wall stud to permit wrapping of the wall stud within the socket.

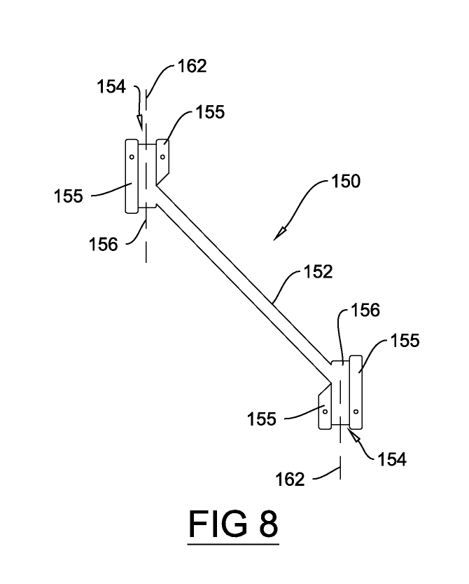

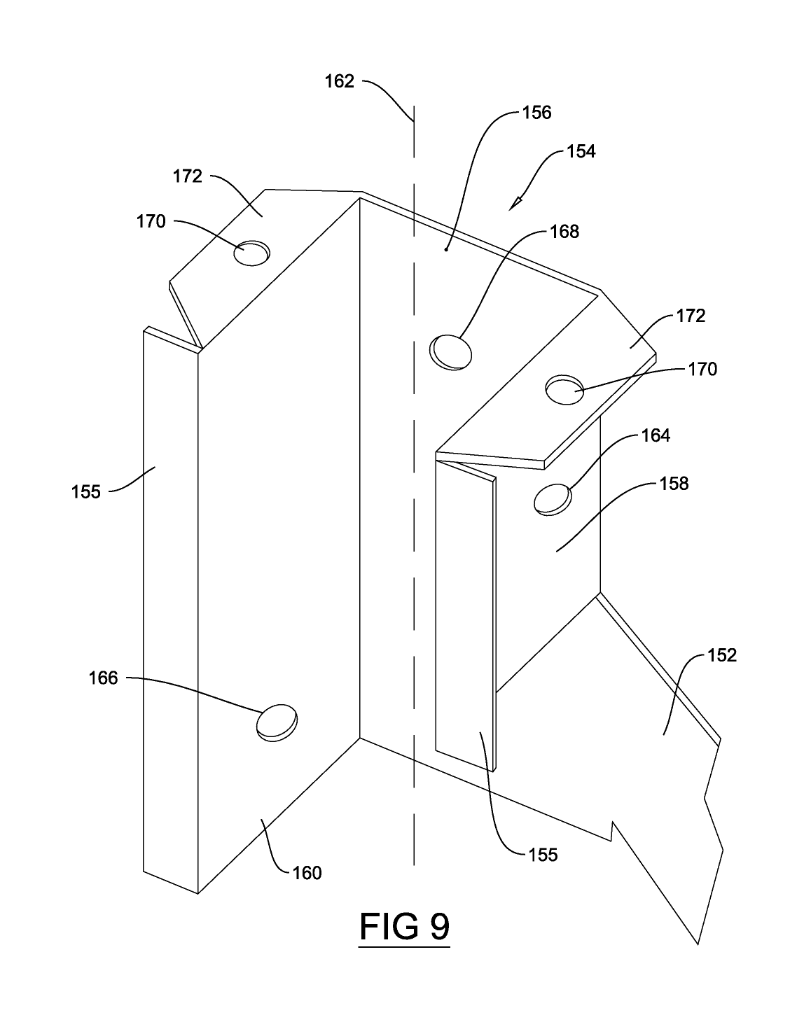

Turning now to FIGS. 8 and 9, an optional embodiment of the present invention is illustrated generally at 150 having a rigid member 152 with end sockets 154 at each end thereof. The end sockets are formed of base panels 156 having first and second side panels, 158 and 160, respectively extending therefrom. The first and second side panels 158 and 160 extend substantially perpendicularly from the base panel 156 so as to form a u-shaped socket along a central axis 162 for receiving the wall stud 6 therein. As described above, the width of the base panel may be selected to space the first and second side panels apart by a distance corresponding to the width of the wall stud such as approximately 1.5 inches (38 mm) for use with a conventional 2×4 dimension lumber wall stud, by way of non-limiting example. Each of the first and second side panels includes fastener bores 164 and 166, respectively, therethrough sized to receive fasteners, such as, by way of non-limiting example, screws or nails therethrough as will be more fully described below. The base panel 156 may also optionally include a fastener bore 168 therethrough.

Each of the first and second side panels 158 and 160 includes an end tab, 170 and 172, respectively extending therefrom away from the central axis 162 of the socket 154. Each end tab 170 and 172 includes a connection bore, 174 and 176 therethrough. The apparatuses 150 as illustrated in FIGS. 8 and 9 may be applied to the wall studs 6 such that a socket of one apparatus is adjacent to and abuts against a corresponding socket of an adjacent apparatus wherein the end tabs 170 and 172 of the sockets will abut against each other. Thereafter fasteners, such as, bolts screws and the like may be passed through the connection bores 174 and 176 so as to secure the sockets 154 to each other.

While specific embodiments of the invention have been described and illustrated, such embodiments should be considered illustrative of the invention only and not as limiting the invention as construed in accordance with the accompanying claims.

What is claimed is:

1. An apparatus for reinforcing adjacent parallel spaced apart wooden structural members to each other, each of the structural members extending between first and second ends and having first and second edges, the apparatus comprising:
a ridged member extending between first and second ends and having a length sufficient to extend between two adjacent structural members;
a socket at each of the first and second ends of said rigid member, each socket being having a central axis therethrough and being formed of a base panel and first and second side panels,
wherein said socket is adapted to engage with a socket of an adjacent rigid member so as to interlink successive rigid members across a plurality of structural members.

2. The apparatus of claim 1 wherein said base panel of each socket is abuttable at against a corresponding base panel wherein said first and second side panels are engagable with corresponding first and second side panels of said adjacent socket.

3. The apparatus of claim 2 wherein said side panels of said socket overlap said side panels of said adjacent socket when said socket is engaged therewith.

4. The apparatus of claim 2 wherein said base panel extends between first and second edges wherein one of said first or second edges abuts against a corresponding first or second edge of said adjacent socket.

5. The apparatus of claim 1 wherein said one of said first or second edge is angularly oriented relative to said central axis.

6. The apparatus of claim 1 wherein said first and second panels include fastener bores therethrough adapted to align with corresponding bores in said first and second panels of said adjacent socket.

7. The apparatus of claim 1 wherein said central axes of said first and second sockets are substantially parallel to each other.

8. The apparatus of claim 1 wherein said rigid member extend diagonally between said first and second sockets, such that said rigid member is angularly oriented relative to said central axis of said first and second socket.

9. The apparatus of claim 1 wherein said first and second side panels are co-formed with said base panel.

10. The apparatus of claim 1 wherein said base panel is co-formed with said rigid member.

11. The apparatus of claim 1 wherein said apparatus is formed of a material selected from the group consisting of metal, plastic, wood and composite materials.

12. The apparatus of claim 1 wherein said first and second side panels include end tabs connectable to adjacent end tabs of an corresponding socket of an adjacent rigid member.

13. A kit for reinforcing adjacent parallel spaced apart wooden structural members, each of the structural members extending between first and second ends and having first and second edges, the kit a plurality of the apparatuses of claim 1.
